(19) United States
(12) Patent Application Publication
(10) Pub. No.: US 2023/0359387 A1
(43) Pub. Date: Nov. 9, 2023

(54) Independent Fragment Compactions of Striped Data

(71) Applicant: Google LLC, Mountain View, CA (US)

(72) Inventor: Michael Lai, Mountain View, CA (US)

(73) Assignee: Google LLC, Mountain View, CA (US)

(21) Appl. No.: 17/662,547

(22) Filed: May 9, 2022

(51) Int. Cl. G06F 3/06

(52) U.S. Cl. CPC G06F 3/0655; G06F 3/0689; G06F 3/0652; G06F 3/0604

(57) ABSTRACT

A method for compacting data includes storing a first plurality of files at a first datacenter and storing a second plurality of files at a second datacenter. The method also includes generating a parity file that includes parity calculations of the first plurality of files and the second plurality of files. The method includes storing the parity file at a third datacenter. The method also includes receiving a request to delete a first file of the first plurality of files stored at the first datacenter and, in response to the request to delete the first file, compacting the parity file stored at the third datacenter. After compacting the parity file, the method includes determining whether a data compaction cost threshold is satisfied. When the data compaction cost threshold is satisfied, the method includes compacting the first plurality of files stored at the first datacenter.

### TECHNICAL FIELD

This disclosure relates to independent fragment compactions of striped data.

### BACKGROUND

Error-detecting codes and error-correcting codes (e.g., parity bits) are commonly used to ensure the integrity of data both during transmission and storage. For example, Reed-Solomon encoding with striping is used as a way to store data to ensure there is redundancy across failure domains. Redundancy array of independent disks (RAID) configurations may employ these techniques to create large and reliable data stores. Specifically, RAID 5 is a common technique used to segment data into different failure domains and one or more parity bits are calculated for redundancy to protect against one or more failures. With RAID 5, a single file is spread across a “row” of the array (i.e., each independent disk stores a portion of the file) such that deleting the file is just a metadata operation indicating that the particular bytes of the file are now unreferenced.

### SUMMARY

One aspect of the disclosure provides a computer-implemented method for compacting data that, when executed by data processing hardware, causes the data processing hardware to perform operations. The operations include storing a first plurality of files at a first datacenter and storing a second plurality of files at a second datacenter. The operations also include generating a parity file that includes parity calculations of the first plurality of files and the second plurality of files. The operations include storing the parity file at a third datacenter. The operations also include receiving a request to delete a first file of the first plurality of files stored at the first datacenter and, in response to the request to delete the first file, compacting the parity file stored at the third datacenter. After compacting the parity file, the operations include determining whether a data compaction cost threshold is satisfied. When the data compaction cost threshold is satisfied, the operations include compacting the first plurality of files stored at the first datacenter.

Implementations of the disclosure may include one or more of the following optional features. In some implementations, generating the parity file comprises determining an exclusive OR between the first plurality of files and the second plurality of files. In some examples, compacting the parity file stored at the third datacenter includes removing a reference to the first file. In some implementations, the first datacenter, the second datacenter, and the third datacenter are each different datacenters. In some of these implemenmations, the first datacenter is located at a first geographical region, the second datacenter is located at a second geographical region, and the third datacenter is located at a third geographical region.

Optionally, compacting the parity file stored at the third datacenter includes determining that a parity compaction cost threshold is satisfied. In some examples, the operations further include, prior to compacting the first plurality of files stored at the first datacenter, determining that a second file of the first plurality of files is inaccessible and recovering the second file using the compacted parity file and the second plurality of files.

In some examples, the operations further include, prior to compacting the first plurality of files stored at the first datacenter, receiving a second request to delete a second file of the second plurality of files stored at the second datacenter and, in response to the second request to delete the second file, re-compacting the compacted parity file stored at the third datacenter. In some implementations, compacting the parity file stored at the third datacenter includes generating a new parity file using each remaining file of the first plurality of files and the second plurality of files and deleting the parity file. The data compaction cost threshold may be based on an amount of data requested to be deleted from the first plurality of files.

Another aspect of the disclosure provides a system for compacting data. The system includes data processing hardware and memory hardware in communication with the data processing hardware. The memory hardware stores instructions that when executed on the data processing hardware cause the data processing hardware to perform operations. The operations include storing a first plurality of files at a first datacenter and storing a second plurality of files at a second datacenter. The operations also include generating a parity file that includes parity calculations of the first plurality of files and the second plurality of files. The operations include storing the parity file at a third datacenter. The operations also include receiving a request to delete a first file of the first plurality of files stored at the first datacenter and, in response to the request to delete the first file, compacting the parity file stored at the third datacenter. After compacting the parity file, the operations include determining whether a data compaction cost threshold is satisfied. When the data compaction cost threshold is satisfied, the operations include compacting the first plurality of files stored at the first datacenter.

This aspect may include one or more of the following optional features. In some implementations, generating the parity file comprises determining an exclusive OR between the first plurality of files and the second plurality of files. In some examples, compacting the parity file stored at the third datacenter includes removing a reference to the first file. In some implementations, the first datacenter, the second datacenter, and the third datacenter are each different datacenters. In some of these implementations, the first datacenter is located at a first geographical region, the second datacenter is located at a second geographical region, and the third datacenter is located at a third geographical region.

Optionally, compacting the parity file stored at the third datacenter includes determining that a parity compaction cost threshold is satisfied. In some examples, the operations further include, prior to compacting the first plurality of files stored at the first datacenter, determining that a second file of the first plurality of files is inaccessible and recovering the second file using the compacted parity file and the second plurality of files.

In some examples, the operations further include, prior to compacting the first plurality of files stored at the first datacenter, receiving a second request to delete a second file of the second plurality of files stored at the second datacenter and, in response to the second request to delete the second file, re-compacting the compacted parity file stored at the third datacenter. In some implementations, compacting the parity file stored at the third datacenter includes generating a new parity file using each remaining file of the first plurality of files and the second plurality of files and deleting the parity file. The data compaction cost threshold may be based on an amount of data requested to be deleted from the first plurality of files.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for compacting data.

FIGS. 2A-2D are schematic views of compacting a parity file and sets of files in response to deletion of a file.

FIG. 3 a flowchart of an example arrangement of operations for a method of compacting data.

FIG. 4 is a schematic view of an example computing device that may be used to implement the systems and methods described herein.

Like reference symbols in the various drawings indicate like elements.

### DETAILED DESCRIPTION

Error-detecting codes and error-correcting codes (e.g., parity hits) are commonly used to ensure the integrity of data both during transmission and storage. For example, Reed-Solomon encoding with striping is used as a way to store data to ensure there is redundancy across failure domains. Redundancy array of independent disks (RAID) configurations may employ these techniques to create large and reliable data stores. Specifically, RAID 5 is a common technique used to segment data into different failure domains and one or more parity bits are calculated for redundancy to protect against one or more failures. With RAID 5, a single file is spread across a “row” of the array (i.e., each independent disk stores a portion of the file) such that deleting the file is just a metadata operation indicating that the particular bytes of the file are now unreferenced.

However, such file distribution is suboptimal with some data abstractions useful in distributed computing environments (e.g., “cloud” computing). For example, when “sharding” data across multiple datacenters (e.g., for reliability or redundancy), each shard or node may include multiple portions of files. In this situation, deletion of a file leaves “holes” in RAID 5 that cannot be easily dereferenced because those bytes may still be needed as part of a parity calculation. While rewriting the entire shard allows for the deleted files to be left out, this is a very expensive operation, as it requires a read across N−1 of the “fragments” of the RAID 5 simultaneously followed by a write of N new fragments. Due to the nature of the distributed computing environments (i.e., where each fragment may be remote from other fragments), these reads and writes incur significant costs (e.g., bandwidth costs).

Implementations herein are directed toward a compaction controller of a distributed computing system that enables independent compaction of each fragment or shard individually. That is, the parity compaction is completed first and independently. Non-parity fragments may then be compacted independently at opportune or optimal times (e.g., when resources are available). The compaction controller stores first files at a first datacenter and second files at a second datacenter. The compaction controller generates and stores a parity file at a third datacenter. The parity file includes parity calculations of the first files and the second files. When a file is deleted from the first files or the second files, the compaction controller compacts the parity file (i.e., dereferences the deleted file(s)). After compacting the parity file, and when a data compaction cost threshold is satisfied, the compaction controller compacts the first files and/or the second files.

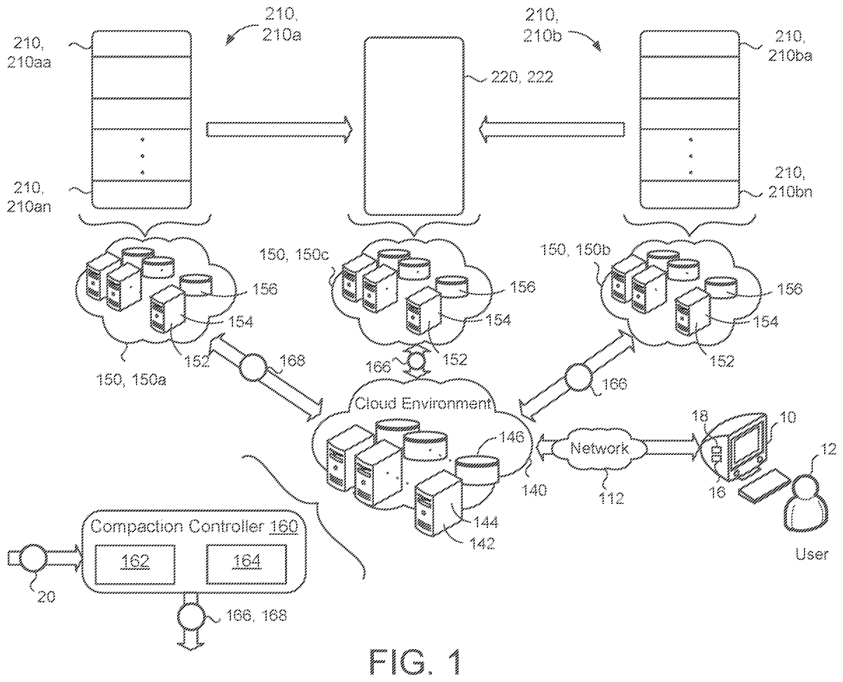

Referring to FIG. 1, in some implementations, an example data compaction system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store (i.e., a remote storage device) may be overlain on the storage resources 146 to allow scalable use of the storage resources 146 by one or more of the clients (e.g., the user device 10) or the computing resources 144.

The remote system 140 includes or is in communication with (e.g., via one or more networks 112) any number of datacenters 150, 150a-n. Each datacenter 150 may include scalable/elastic resources 152 including computing resources 154 (e.g., data processing hardware) and/or storage resources 156 (e.g., memory hardware). In some examples, these resources 152 are a part of the remote system resources 142 (e.g., a distributed computing network distributed across multiple datacenters 150). In other examples, the datacenters 150 are part of a distributed computing environment that is independent from the remote system 140. In this example, the remote system 140 includes or is in communication with a first datacenter 150a, a second datacenter 150b, and a third datacenter 150c. One or more of the datacenters 150 may be co-located with the remote system 140. In some examples, the first datacenter 150a is located in a first geographical region, the second datacenter 150b is located in a second geographical region, and the third datacenter 150c is located in a third geographical region. Each geographical region may be different. For example, each datacenter 150 is geographically remote from each other datacenter 150 to improve resiliency of the distributed computing system (e.g., against natural disasters) and/or to locate computing resources in closer proximity to users 12.

The datacenters 150 each store one or more files 210, 210a-n (e.g., data blocks or other logical grouping of data). Each file 210 is, for example, associated with a particular user 12 or other entity. Here, the first datacenter 150a stores a first set of files 210, 210aa-an and the second datacenter 150b stores a second set of files 210, 210ba-bn, although any number of datacenters 150 may store any number of sets of files 210. In some examples, at least some of the first set of files 210a is different than the second set of files 210b. That is, the second set of files 210b need not be a copy of the first set of files 210a and in some examples, each file 210 of the first set of files 210a is different than each file 210 of the second set of files 210b.

Commonly, data (i.e., files 210) is duplicated across different “zones” (i.e., different datacenters 150 at different geographical regions) to provide redundancy and fault tolerance for users 12. However, such redundancy requires at least a doubling of storage space (i.e., as each file 210 is copied). As storage requirements continue to grow, such increases in storage are increasingly less tolerable. Instead of duplicating the files 210, the remote system 140 provides redundancy and resiliency via an error detection and/or error correction techniques such as parity hits. Here, the remote system 140 executes a compaction controller 160 that generates a parity file 220 that includes parity calculations 222 of the first set of files 210a and the second set of files 210b. For example, the parity file 220 includes an exclusive OR (XOR) between the first set of files 210a and the second set of files 210b, although the parity file 220 may be generated using any known error correction techniques.

The compaction controller 160 stores the parity file 220 at the third datacenter 150c that may be remote from both the first datacenter 150a and the second datacenter 150b. When a file 210 is lost at either the first datacenter 150a or the second datacenter 150b, the file 210 may be recovered using a combination of the parity file 220 and the other set of files 210. For example, when a file 210a in the first set of files 210a is lost (e.g., corrupted due to a hardware or software failure of the datacenter 150a), the compaction controller 160 may recover the lost file 210a using the parity file 220 and the second set of files 210b (e.g., by XORing some or all of the parity file 220 with some or all of the second set of files 210b). Additionally, the parity file 220 can be recovered from the first set of files 210a and the second set of files 210b. Thus, the parity file 220 provides redundancy for both the first set of files 210a and the second set of files 210b while requiring less overall storage space than duplicating both sets of files 210a, 210b.

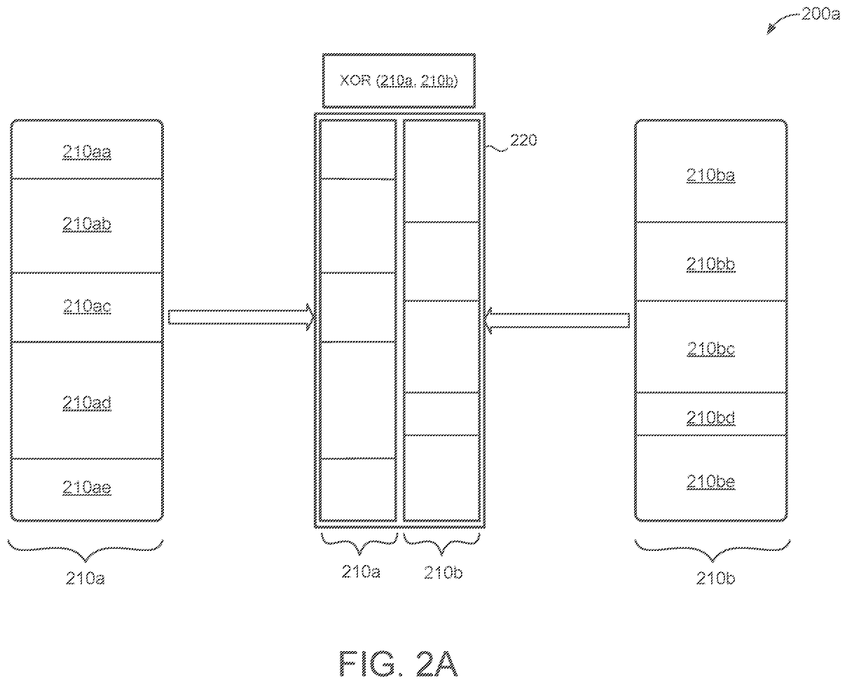

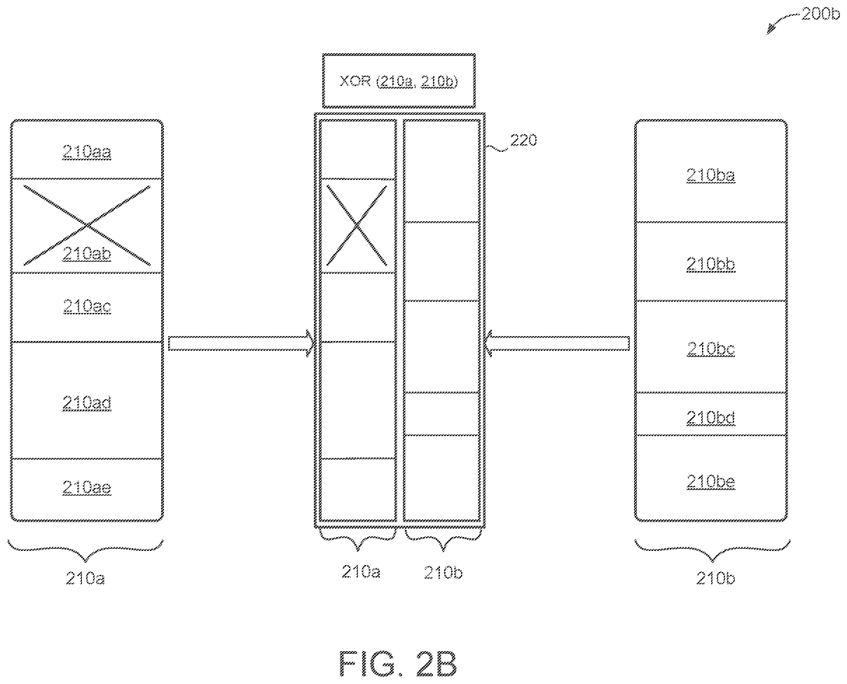

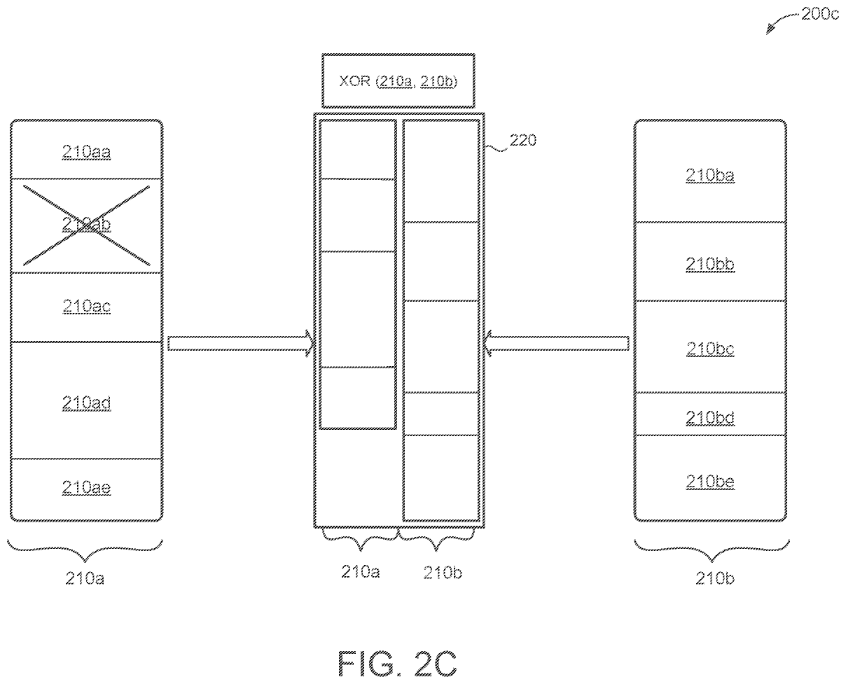

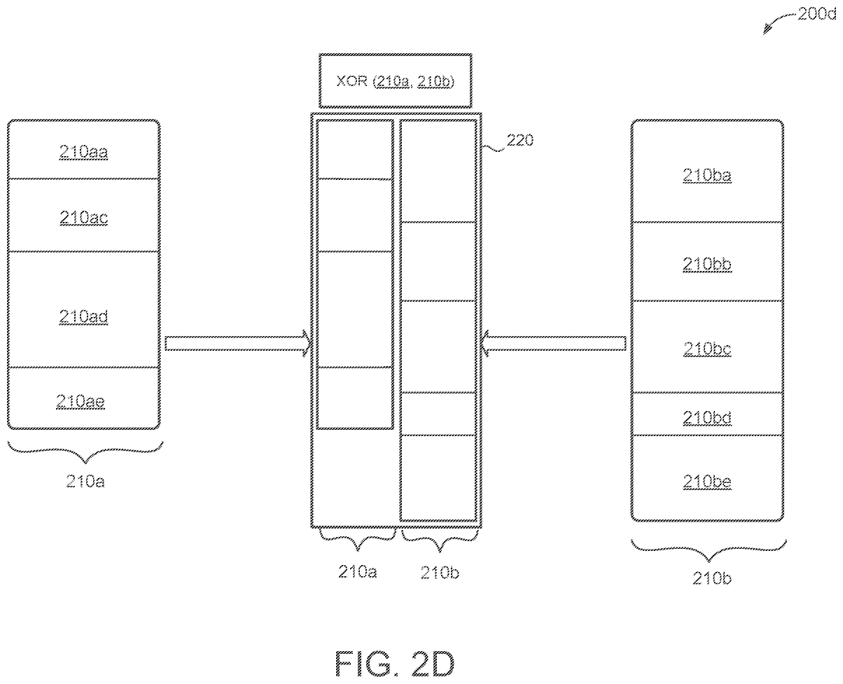

In some examples, the compaction controller 160 receives a request 20 to delete one or more files 210 from either the first set of files 210a or the second set of files 210b. For example, the user 12 transmits the request 20 to the remote system 140 via the network 112. In other examples, the remote system 140 generates the request 20 (e.g., due to a data policy, such as a data retention policy). The compaction controller 160, in response to the request 20 to delete the file 210, compacts the parity file 220. Compaction of the parity file 220 is discussed in more detail below with regard to FIGS. 2A-2D. In some examples, compaction of the parity file 220 includes the compaction controller 160 determining that a parity compaction cost threshold 162 is satisfied. For example, the compaction controller 160 determines that compacting the parity file 220 will result in a cost savings (e.g., space savings) that exceeds a cost (e.g., bandwidth cost, computational cost, etc.) to perform the compaction. The compaction controller 160 may be at least partially implemented on one or more datacenters 150, allowing the datacenters 150 independent evaluation of when to compact their respective sets of files 210.

After compacting the parity file 220, the compaction controller 160 determines whether a data compaction cost threshold 164 is satisfied, and when the data compaction cost threshold 164 is satisfied, the compaction controller 160 compacts the set of files 210 that includes the file 210 requested to be deleted by the request 20. That is, after compacting the parity file 220, the compaction controller 160 independently determines when the sets of files 210 should be compacted (i.e., dereference deleted files 210). Thus, the compaction controller 160 decouples parity compaction from data compaction and allows the cost of the compaction (e.g., network costs) to be both deferred and spread out over a longer period of time, easing the burden the compaction typically causes. This is advantageous, because compactions typically require a significant amount of reading and writing of the data. When all of the data is co-located (e.g., within the same datacenter 150), the bandwidth to support such compactions may 1s be readily available. However, when the files 210 are spread across multiple datacenters 150 in different geographical regions, such that data transfer occurs over wide area networks (WANs) instead of local area networks (LANs), the bandwidth cost can be considerable.

In some implementations, the data compaction cost threshold 164, which may be different than the parity compaction cost threshold 162, is based on an amount of data requested to be deleted from the set of files 210. That is, as the amount of data that has been requested to be deleted from a set of files 210 grows, the compaction controller 160 may determine it is appropriate to compact the set of files 210. The compaction controller 160 may include any number of factors in the determination, such as the amount of computational resources available, the amount of bandwidth resources available, the time of day, etc.

The compaction controller 160 may trigger or command the compactions using a parity compaction command 166 and/or a data compaction command 168. For example, when the compaction controller 160 determines that the parity compaction cost threshold 162 and/or the data compaction cost threshold 164 are satisfied, the compaction controller 160 generates the respective parity compaction command 166 or data compaction command 168. These commands 166, 168, may be configured to cause the respective datacenters 150 to perform the requisite compactions. The commands 166, 168 may originate from the remote system 140 and/or any of the datacenters 150. That is, the compaction controller 160 may at least partially execute on one or more datacenters 150.

Referring now to FIG. 2A, a schematic view 200a includes a first set of files 210a that includes five files 210aa-ae. A second set of files 210b also includes five different files 210ba-be. In this example, the parity file 220 includes an XOR of the bits of the first set of files 210a and the second set of files 210b The parity file 220 allows reconstruction of the first set of files 210a by using the second set of files 210b and similarly allows reconstruction of the second set of files 210b by using the first set of files 210a. For illustration purposes, a length of the first set of files 210a in this example is approximately the same as a length of the second set of files 210b.

FIG. 2B shows a schematic view 200b that includes the exemplary sets of files 210a, 210b and the parity file 220 from FIG. 2A. Here, a request 20 has requested that the file 210ab be deleted from the first set of files 210a The compaction controller 160 may track that the file 210 has been marked for deletion through any means (e.g., a metadata table). The compaction controller 160 may wait any period of time before performing any compactions (i.e., recover the space occupied by the deleted file 210a). For example, the compaction controller 160 waits until the parity compaction cost threshold 162 is satisfied. This may include waiting for multiple files 210 to be deleted, for more resources to be available, for demand to decrease, etc.

Referring now to FIG. 2C, continuing the example from FIGS. 2A and 2B, the compaction controller 160 compacts the parity file 220. This may include removing a reference to the deleted file 210ab For example, the parity file 220 may recalculate the XOR of the first set of files 210a (now missing file 210ab) with the second set of files 210b. As shown in FIG. 2C, the length of the first set of files 210a used to calculate the parity within the parity file 220 is now shorter by the length of the deleted file 210ab This recovers the storage space previously occupied by the parity calculations based on the deleted file 210ab. The parity compaction may involve reading some or all of the first set of files 210a and/or the second set of files 210b. At this point, the parity file 220 has been compacted, but the first set of files 210a has not yet been compacted (i.e., the storage space dedicated to the deleted file 210ab has not been dereferenced). That is, the compaction of the parity file 220 is independent from the compaction of the first set of files 210a.

Despite this independence, the compacted parity file 220 still allows for recovery of“live” (i.e., not deleted) data from the first set of files 210a. That is, in the event of a failure of the first datacenter 150 that stores the first set of files 210a, the parity file 220 (stored at the third datacenter 150c) and the second set of files 210b (stored at the second datacenter 150b) can together reconstruct the files 210aa, 210c-e. Thus, in some examples, the compaction controller 160, prior to compacting the first set of files 210a, determines that a file 210 of the first set of files 210a is inaccessible and recovers the file 210 using the compacted parity file 220 and the second set of files 210b. In some implementations, the compaction controller 160 maintains the original parity file 220 while generating a new compacted parity file 220 based on the deleted files 210. Once the new compacted parity file 220 is generated, the compaction controller 160 may fully delete the original parity file 220 (i.e., reclaim the storage space occupied by the original parity file 220).

Referring now to FIG. 2D, the first set of files 210a may remain un-compacted (i.e., include deleted files 210) for some period of time after the compaction of the parity file 220 (FIG. 2C). After the data compaction cost threshold 164 is satisfied, the compaction controller 160 may opt to compact the first set of files 210a to reclaim the space occupied by the deleted file 210ab. After the compaction, the first set of files 210a reflects the compacted parity file 220. The data compaction cost threshold 164 may be based on an amount of data that has been deleted. For example, the compaction controller 160 waits until enough files 210 have been deleted that a threshold amount of storage space will be reclaimed with a compaction. That is, while examples herein illustrate compaction being performed after a single file 210 is deleted, it may be more practical (i.e., efficient or less expensive) to perform compactions after several files 210 have been marked for deletion. Additionally or alternatively, the data compaction cost threshold 164 is based on an amount of resources available, a current or forecasted amount of demand, schedules, etc. In some implementations, the compaction controller 160 maintains the original set of files 210 while generating a new compacted set of files 210 based on the deleted files 210. Once the new compacted set of files 210 is generated, the compaction controller 160 may fully delete the original set of files 210 (i.e., reclaim the storage space occupied by the original set of files 210).

The parity compaction cost threshold 162 and the data compaction cost threshold 164 may be different and thus may lead to radically different compaction schedules. Continuing the example set forth in FIGS. 2A-2D, in some implementations, the compaction controller 160, after compacting the parity file 220 and prior to compacting the first set of files 210a, receives a request 20 to delete a second file 210b stored at the second datacenter 150b In this example, the compaction controller 160, in response to the second request 20 to delete the second file 210b, re-compacts the compacted parity file at the third datacenter 150b. That is, the compaction controller 160 may opt to compact the parity file 220 a second time prior to compacting the first set of files 210a or the second set of files 210b, as the compaction of files 210 is independent 1s from the compaction of the parity file 220.

Thus, the compaction controller 160 allows for parity compaction (or other error correcting/detecting files) first and independent and, at any point later in time, compaction of non-parity fragments. This allows for best effort resources because, as the operations are independent, the resources (e.g., bandwidth, computational, etc.) are not required to all be available at the same time.

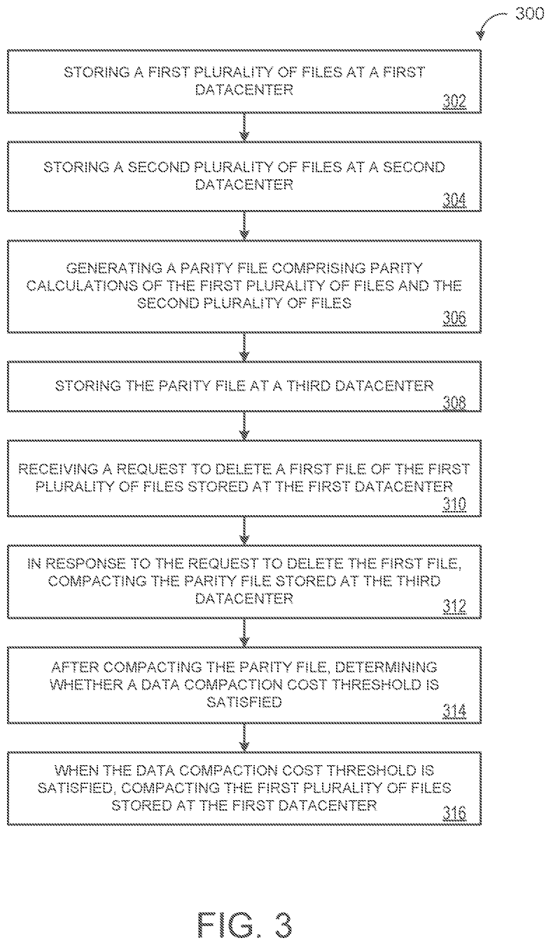

FIG. 3 is a flowchart of an exemplary arrangement of operations for a method 300 of independent fragment compactions of data. The computer-implemented method, when executed by data processing hardware 144, causes the data processing hardware 144 to perform operations. The method 300, at operation 302, includes storing a first plurality of files 210a at a first datacenter 150a and, at operation 304, storing a second plurality of files 210b at a second datacenter 150b. The method 300, at operation 306, includes generating a parity file 220 that includes parity calculations 222 of the first plurality of files 210a and the second plurality of files 210b. At operation 308, the method 300 includes storing the parity file 220 at a third datacenter 150c. The method 300, at operation 310, includes receiving a request 20 to delete a first file 210 of the first plurality of files 210a stored at the first datacenter 150a and, at operation 312, in response to the request 20 to delete the first file 210, compacting the parity file 220 stored at the third datacenter 150. The method 300, at operation 314, includes, after compacting the parity file 220, determining whether a data compaction cost threshold 164 is satisfied. When the data compaction cost threshold 164 is satisfied, the method 300, at operation 316, includes compacting the first plurality of files 210a stored at the first datacenter 150a.

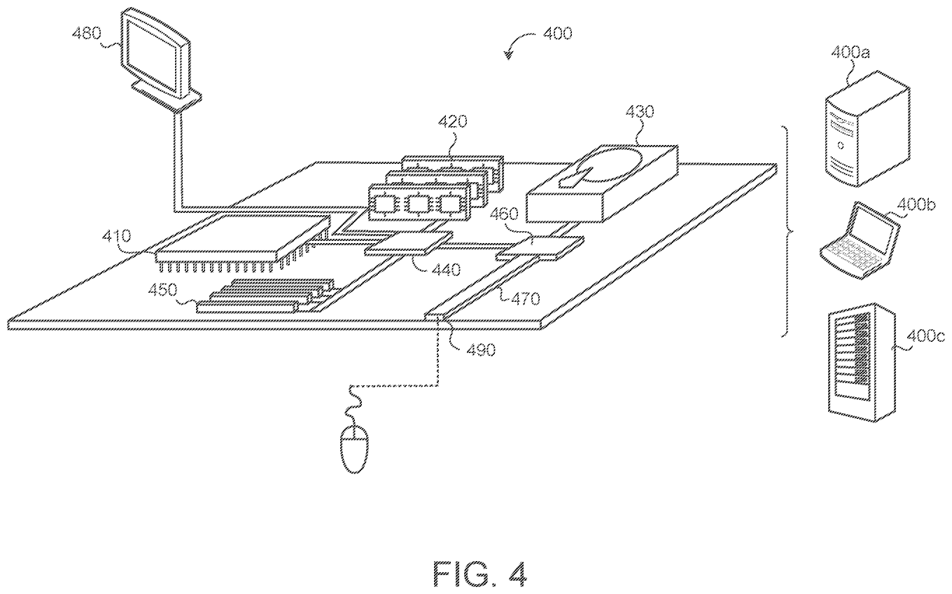

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM. EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
storing a first plurality of files at a first datacenter;
storing a second plurality of files at a second datacenter;
generating a parity file comprising parity calculations of the first plurality of files and the second plurality of files;
storing the parity file at a third datacenter;
receiving a request to delete a first file of the first plurality of files stored at the first datacenter;
in response to the request to delete the first file, compacting the parity file stored at the third datacenter;
after compacting the parity file, determining whether a data compaction cost threshold is satisfied; and
when the data compaction cost threshold is satisfied, compacting the first plurality of files stored at the first datacenter.

2. The method of claim 1, wherein generating the parity file comprises determining an exclusive OR between the first plurality of files and the second plurality of files.

3. The method of claim 1, wherein compacting the parity file stored at the third datacenter comprises removing a reference to the first file.

4. The method of claim 1, wherein the first datacenter, the second datacenter, and the third datacenter are each different datacenters.

5. The method of claim 4, wherein:
the first datacenter is located at a first geographical region,
the second datacenter is located at a second geographical region; and
the third datacenter is located at a third geographical region.

6. The method of claim 1, wherein compacting the parity file stored at the third datacenter comprises determining that a parity compaction cost threshold is satisfied.

7. The method of claim 1, wherein the operations further comprise, prior to compacting the first plurality of files stored at the first datacenter:
determining that a second file of the first plurality of files is inaccessible; and
recovering the second file using the compacted parity file and the second plurality of files.

8. The method of claim 1, wherein the operations further comprise, prior to compacting the first plurality of files stored at the first datacenter:
receiving a second request to delete a second file of the second plurality of files stored at the second datacenter; and
in response to the second request to delete the second file, re-compacting the compacted parity file stored at the third datacenter.

9. The method of claim 1, wherein compacting the parity file stored at the third datacenter comprises:
generating a new parity file using each remaining file of the first plurality of files and the second plurality of files; and
deleting the parity file.

10. The method of claim 1, wherein the data compaction cost threshold is based on an amount of data requested to be deleted from the first plurality of files.

11. A system comprising:
data processing hardware; and
memory hardware in communication with the data processing hardware, the memory hardware storing instructions that when executed on the data processing hardware cause the data processing hardware to perform operations comprising:
storing a first plurality of files at a first datacenter;
storing a second plurality of files at a second datacenter;
generating a parity file comprising parity calculations of the first plurality of files and the second plurality of files;
storing the parity file at a third datacenter;
receiving a request to delete a first file of the first plurality of files stored at the first datacenter;
in response to the request to delete the first file, compacting the parity file stored at the third datacenter;
after compacting the parity file, determining whether a data compaction cost threshold is satisfied; and
when the data compaction cost threshold is satisfied, compacting the first plurality of files stored at the first datacenter.

12. The system of claim 11, wherein generating the parity file comprises determining an exclusive OR between the first plurality of files and the second plurality of files.

13. The system of claim 11, wherein compacting the parity file stored at the third datacenter comprises removing a reference to the first file.

14. The system of claim 11, wherein the first datacenter, the second datacenter, and the third datacenter are each different datacenters.

15. The system of claim 14, wherein
the first datacenter is located at a first geographical region;
the second datacenter is located at a second geographical region, and
the third datacenter is located at a third geographical region.

16. The system of claim 11, wherein compacting the parity file stored at the third datacenter comprises determining that a parity compaction cost threshold is satisfied.

17. The system of claim 11, wherein the operations further comprise, prior to compacting the first plurality of files stored at the first datacenter:
determining that a second file of the first plurality of files is inaccessible; and
recovering the second file using the compacted parity file and the second plurality of files.

18. The system of claim 11, wherein the operations further comprise, prior to compacting the first plurality of files stored at the first datacenter:
receiving a second request to delete a second file of the second plurality of files stored at the second datacenter; and
in response to the second request to delete the second file, re-compacting the compacted parity file stored at the third datacenter.

19. The system of claim 11, wherein compacting the parity file stored at the third datacenter comprises:
generating a new parity file using each remaining file of the first plurality of files and the second plurality of files; and
deleting the parity file.

20. The system of claim 11, wherein the data compaction cost threshold is based on an amount of data requested to be deleted from the first plurality of files.
